(19) United States
(12) Patent Application Publication
(10) Pub. No.: US 2008/0034552 A1
(43) Pub. Date: Feb. 14, 2008

(54) HINGE FOR A MOTOR VEHICLE

(75) Inventor: Binh NGUYEN, Toronto (CA)

Correspondence Address: PILLSBURY WINTHROP SHAW PITTMAN, LLP, P.O. BOX 10500, MCLEAN, VA, 22102, US

(73) Assignee: Ventra Group, Inc., Bradford (CA)

(21) Appl. No.: 11/675,164

(22) Filed: Feb. 15, 2007

Related U.S. Application Data
(60) Provisional application No. 60/836,688, filed on Aug. 10, 2006.

(51) Int. Cl. E05D 11/06

(52) U.S. Cl. 16/375; 16/374

(57) ABSTRACT

A hinge for use in a motor vehicle, including first and second members pivotably coupled to each other. First and second position retainers are coupled between the first member and the second member to releasably secure the second member in a first holding position relative to the first member. The first position retainer has a first holding portion and the second position retainer has a second holding portion such that one of the first and second position retainers is structured and arranged to move relative to the other of the first and second position retainers such that the first and second holding portions move into and out from a first holding position. The first and second holding portions are structured and arranged to be releasably secured to each other in the first holding position.

The present application claims priority to U.S. Provisional Application Ser. No. 60/836,688, the entirety of which is hereby incorporated into the present application by reference.

### FIELD OF THE INVENTION

The present invention relates to a hinge. More specifically, the present application provides illustrated embodiments of the present invention, including those relating to a hinge for use, for example, in a motor vehicle.

### BACKGROUND

One example of a prior art mechanism for maintaining a trunk lid in an open position includes a gas spring, as disclosed in U.S. Pat. No. 6,520,557 to Benthaus et al., which is incorporated herein in its entirety by reference thereto.

Another example of a known hinge is one using a 4-bar linkage. This hinge is shown in drawings accompanying an Information Disclosure Statement filed with this application. This prior hinge uses two different stops: one for abutting the closure connecting part to support it in the open position, and another for abutting the body connecting part for maintaining clearance in the closed position. This two stop approach has been recognized as undesirable by the inventor for two reasons. First, it introduces additional costs and labor, as it requires two stops to implement. Second, the presence of two stops creates geometrical restrictions that make the hinge difficult to fit into smaller environments.

### SUMMARY OF THE INVENTION

One aspect of the invention relates to a hinge for use in a motor vehicle, where only one stop is used for providing the abutment in both the open and closed positions. The hinge comprises: a first member; a second member coupled to the first member so that the second member may move with respect to the first member such that the second member may move in an opening direction, which is away from the first member and towards an open position, and in a closing direction, which is away from the open position and towards the first member and a closed position; and a third member coupled between the first member and the second member. The third member may optionally releasably secure the second member in a first holding position relative to the first member. The third member includes a stop element positioned such that the stop element abuts the second member when the second member is in the open position to keep the second member from further moving in the opening direction, the position of the stop element further permitting the stop element to abut the first member when the second member is in the closed position to provide clearance between the first member and the second member when in the closed position.

Another aspect of the invention relates to a hinge assembly for a motor vehicle, comprising a first member coupled to a first part of a motor vehicle; a second member coupled to an access panel (i.e., a closure) of the motor vehicle and being coupled to the first member so that the access panel may move with respect to the first part of the motor vehicle such that the access panel may move in an opening direction, which is away from the first part and towards an open position, and in a closing direction, which is away from the open position and towards the first part and a closed position; and a third member coupled between the first member and the second member. The third member may optionally releasably secure the access panel in a first holding position relative to the first part. The third member includes a stop element positioned such that the stop element abuts the second member when the access panel is in the open position to keep the access panel from further moving in the opening direction, the position of the stop element further permitting the stop element to abut the first member when the access panel is in the closed position to provide clearance between the first member and the second member when in the closed position.

Other aspects, features, and advantages of this invention will become apparent from the following detailed description when taken in conjunction with the accompanying drawings, which are a part of this disclosure and which illustrate, by way of example, the principles of this invention.

### BRIEF DESCRIPTION OF THE DRAWINGS

The accompanying drawings facilitate an understanding of the various embodiments of this invention. In such drawings:

FIGS. 1-3 illustrate perspective views of a hinge in the closed position, in accordance with one illustrated embodiment of the present invention;

FIG. 4 illustrates a top view of the hinge of FIG. 1;

FIG. 5 illustrates a front view of the hinge of FIG. 1;

FIG. 6 illustrates a side view of the hinge of FIG. 1 but in the open position;

FIG. 7 illustrates an enlarged view of FIG. 6 to show the adjustable fastener;

FIG. 8 illustrates a side view of the hinge of FIG. 1 in the closed position;

FIG. 9 illustrates an isolated, side view of the link with the stop element from the hinge of FIG. 1; and

FIG. 10 illustrates a side view of the hinge of FIG. 1 in the closed position and with the hinge elements in the open position shown in phantom lines.

### DESCRIPTION OF ILLUSTRATED EMBODIMENTS

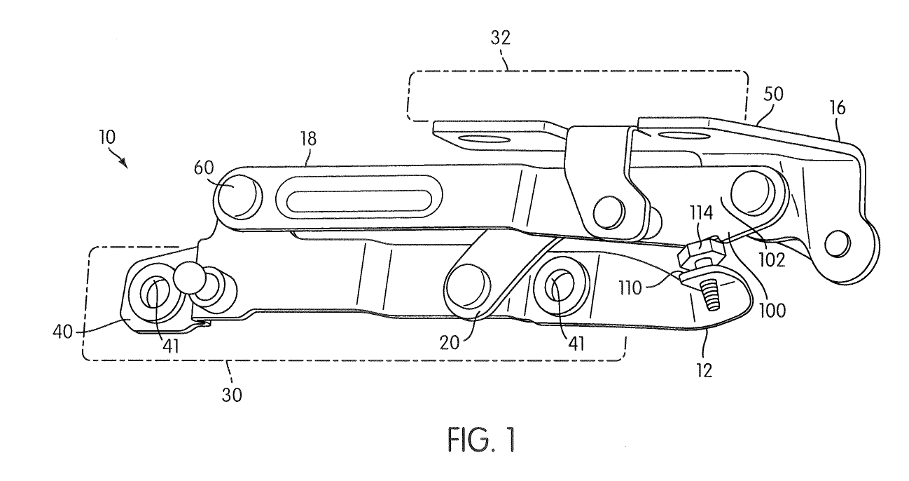

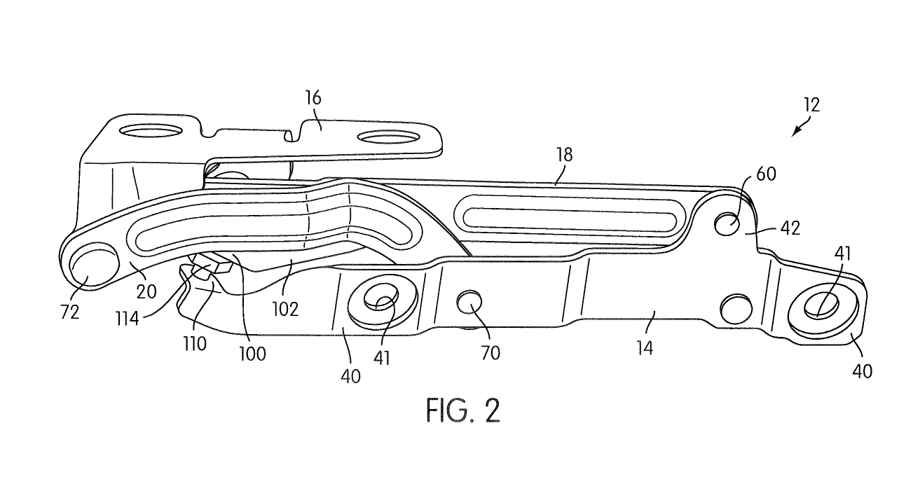

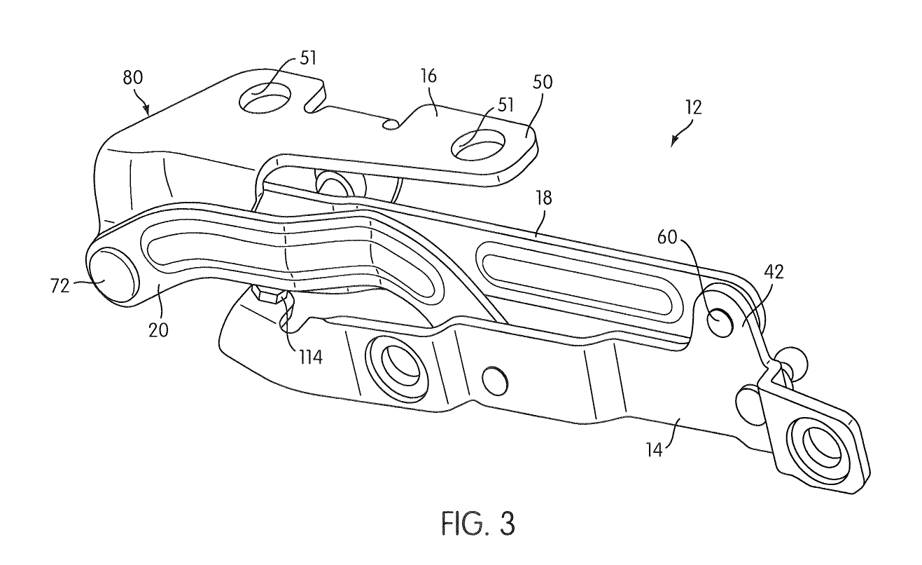

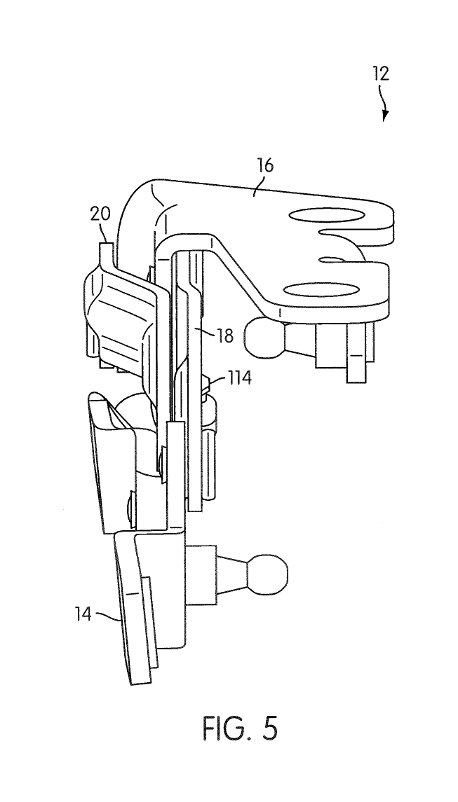

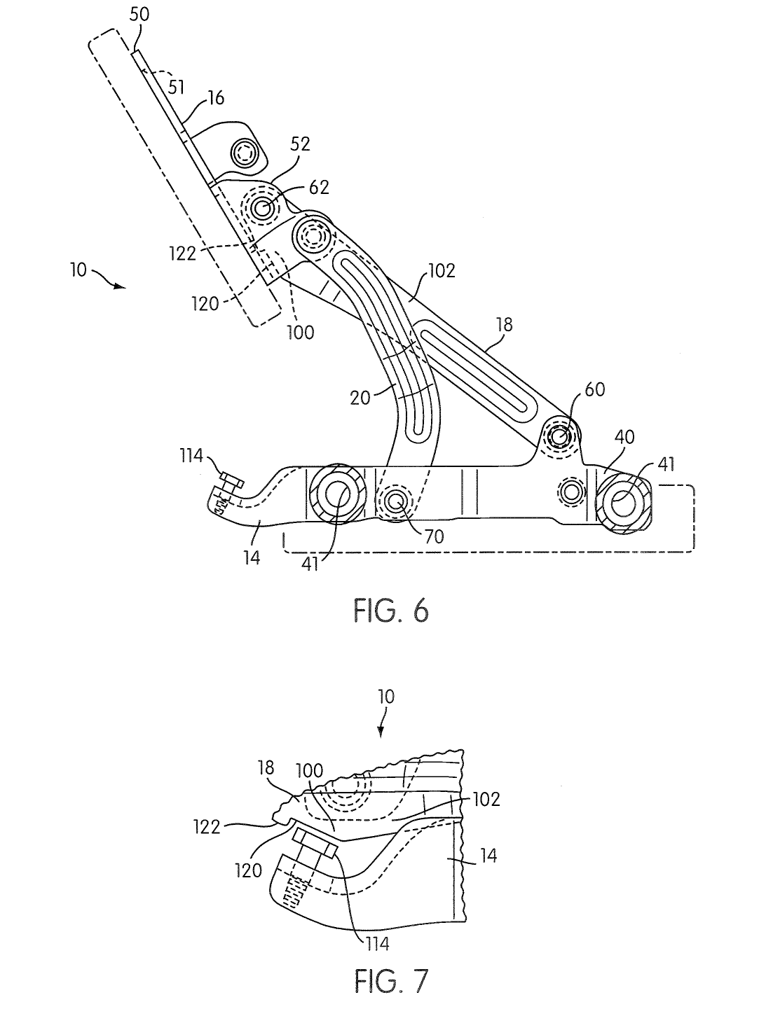

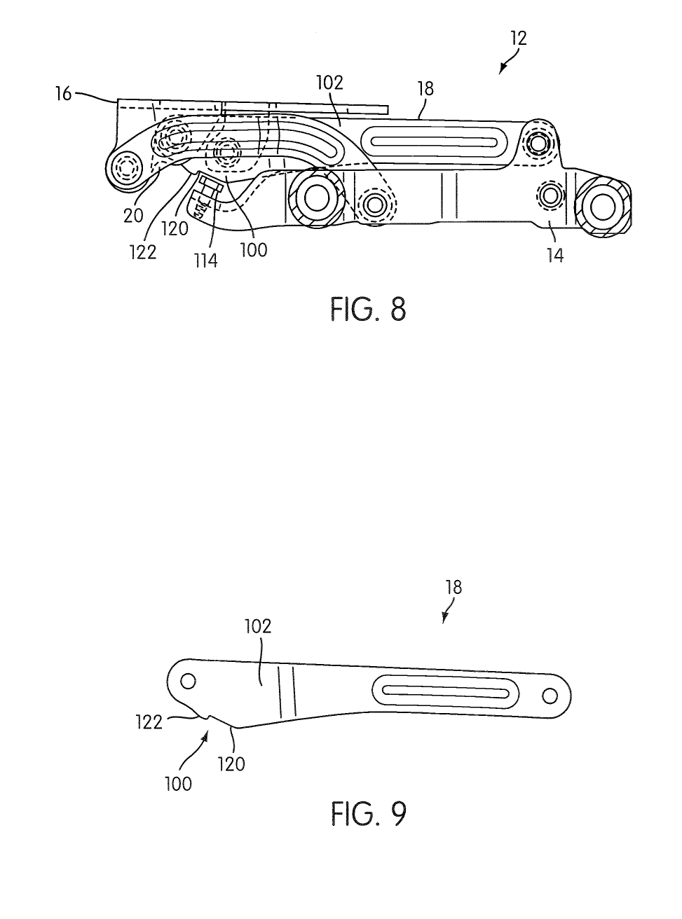

FIGS. 1-10 illustrate one embodiment of the subject invention. FIG. 1 shows a hinge assembly 10, including a hinge 12 having a first member 14 and a second member 16 pivotably coupled to the first member 14 so that the second member 16 may move in an articulating manner with respect to the first member 14. Coupled between the first and second members 14 and 16 are a third member 18 and a fourth member 20. One embodiment of the hinge 12 includes its use in a pivoting connection between two parts 30 and 32 of a motor vehicle such that a second part 32 may pivot relative to a first part 30. For example, the second part 32 may include an access panel or closure, such as a hood or a trunk lid of a motor vehicle. Thus, the hinge assembly 10 may provide a hinge that is easier to install, uses fewer parts, and/or is less expensive than previous hinges used for motor vehicle hoods and trunk lids.

Although the hinge 12 can take various forms, in the illustrated embodiment of FIGS. 1-10, the hinge 12 is configured as a hinge for a motor vehicle, for example, a hinge for permitting the pivoting of a trunk to access the inner, rear part of the motor vehicle. FIG. 1 shows first member 14 as a first link having a connecting part 40 for connecting to a first part 30 of the motor vehicle body, such as a rear frame member, and a lug 42 that pivotally connects to the third link 18. Second member 16 is shown as a second link having a connecting part 50 for connecting to the hood 32 or other part of the vehicle that is pivoted, and a lug 52 that connects to the other members or links 18 and 20. The connections between the links 14 and 16 and their respective parts 30 and 32 of the motor vehicle may be made by any appropriate fastening mechanisms such as by fasteners extending through openings 41 extending through connecting part 40 and through openings 51 extending through connecting part 50.

The connecting part 40 of the first member 14 may be referred to as a body connecting part when used to connect to a body; and the second connecting part 50 of the second member 16 may be referred to as a closure connecting part when used to connect to a closure.

Third member 18 is shown as a third link that extends between the first and second links 14 and 16 and is pivoted at one end to first link 14 via pivot coupling 60 and pivoted at its other end to second link 16 via pivot coupling 62. Fourth member 20 is shown as a fourth link that extends between the first and second links 14 and 16 and is pivoted at one end to first link 14 via pivot coupling 70 and pivoted at its other end to link 16 via pivot coupling 72. The pivot couplings 60, 62, 70, and 72 may be any appropriate couplings that provide appropriate fastening while providing the necessary pivoting between the members 14, 16, 18, and 20, for example, the pivoting pins may be employed.

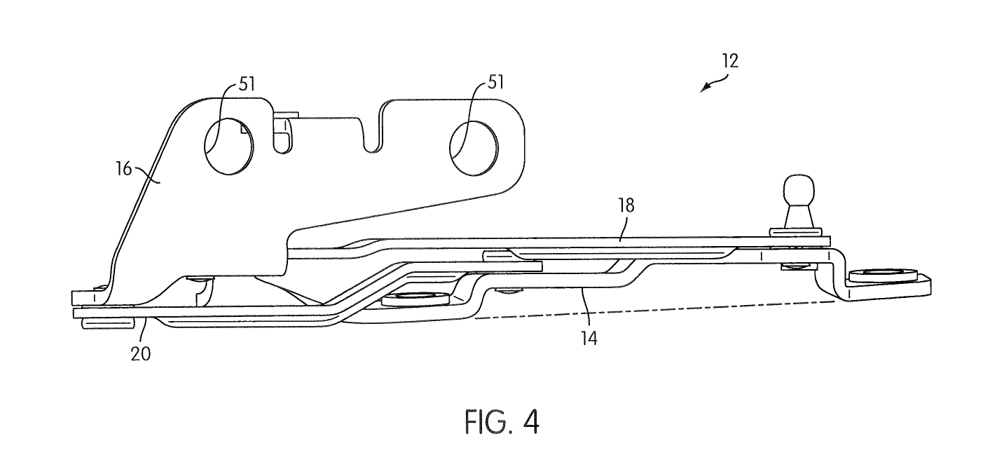

Thus, links 14, 16, 18, and 20 form a hinge linkage 80 that permits the second vehicle part 32 to pivot with respect to the first vehicle part 30, and releasably secures the second link 16 in its open position against backward movement by an over center action as the pivotal couplings cross over one another (see FIG. 6). Although links 14, 16, 18, and 20 are each illustrated as a unitary element, each link may be formed as a combination of any number of elements. Also, links 14, 16, 18, and 20 may be formed of any appropriate material, including metal. Additionally, although the links 14, 16, 18, 20 illustrated in FIG. 1 are arranged as a four-bar linkage, it should be appreciated that various linkages may be employed to accomplish the function of permitting the first part 30 to pivot relative to the second part 32. It is not necessary that four links be used, and only a third link need be used. That third link may be provided with structure, such as a detent or other engagement, to releasably secure the second link in the open position in such an arrangement, but this is optional. Such releasable securement is desirable where the closure moves vertically, so that it can be supported against closing by gravity.

Even though only one linkage 80 is shown as providing the pivoting mechanism between the first and second parts 30 and 32 of the vehicle, any number of linkages 80 may be employed to appropriately support and provide pivoting for the desired part 32 to be pivoted. For example, hoods or trunk lids are commonly pivoted at two points that are positioned on opposite ends of the respective hood or trunk lid. In such a case, two linkages 80 may be employed for a hood or trunk lid, at opposite ends of the hood or lid, with each of the two linkages 80 being substantially identical. Of course, the two opposing linkages 80 may be configured as mirror images of one another.

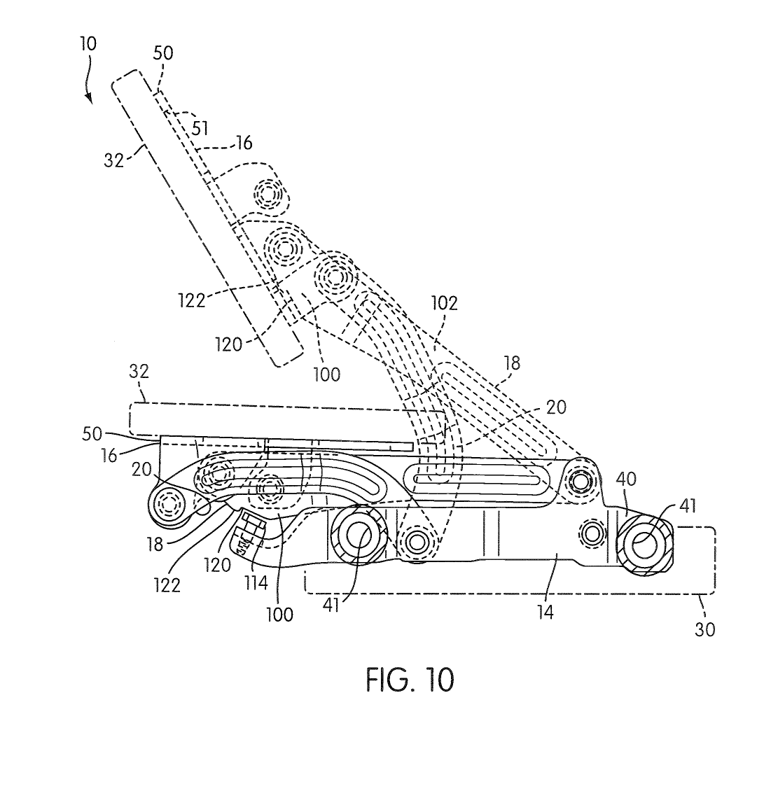

Link 18 includes a stop element 100 that may be rigidly connected to a main portion 102 of link 18. The stop element 100 is positioned on the main portion 102 in such a way that, together with the structure and configuration of the main portion 102 and the other elements of the hinge 12, a stop surface of the stop element 100 abuts the second link 16 when the second link 16 is in the open position (as seen in FIGS. 6 and 10) to keep the second link 16 from further pivoting away from the first link 14 in the opening direction. This is beneficial when combined with the ability to releasably secure the second link 16 in the open position, as that releasable securement prevents the closure from moving in the closing direction, while the stop prevents it from going too far in the opening direction. This provides a stable open position for the closure.

The position of the stop element 100 on the main portion 102, together with the structure and configuration of the main portion 102 and the other elements of the hinge 12, also permits the same stop surface of the stop element 100 to abut the first member 14 when the second member 16 is in the closed position to provide clearance between the first member 14 and the second member 16 when in the closed position. Thus, the stop element 100 provides a physical stop to further movement of the hinge 12 in both the open position and in the closed position, and preferably there only one stop element. As illustrated, the stop element 100 provides a single element that abuts the second link 16 in the open position and abuts the first link 14 in the closed position. The illustrated embodiments provide an increase in efficiency and a savings of materials.

As seen in FIGS. 1 and 2, the stop element 100 may include a rigid support 110, which may be rigidly secured to the main portion 102. The stop element 110 may be made of any appropriate material that permits the stop element 110 to act as a stopper, including a material that will cushion the contact or protect the contact surfaces on links 14 and 16. The stop element 110 may also include a resilient or protective element or surface to provide a predetermined level of cushioning and protection between the first and second links 14 and 16 when the stop element 100 comes into contact with the contact surfaces, which may also have resilient or protective surfaces thereon. Although in the figures, the stop element 100 is shown as abutting the first and second links 14 and 16, it should be understood that the stop element 100 may instead abut other elements that are connected to the first or second links 14 and 16, including the vehicle parts 30 and 32. The element to which the stop element 100 abuts may be integrally formed with the links 14 and 16 or be other, distinct elements. In the illustrated embodiments, the first link 14 includes an adjustable head 114 for providing the contacting surface on link 14 for stop element 100. The adjustable head 114 may take various forms but is illustrated as a threaded fastener that can be turned and adjustably positioned relative to the other portions of the first link 14.

As seen in FIGS. 3-10 and, in particular in FIGS. 6 and 10, the stop element 100 may be integrally formed with the third link 18 as a unitary element and include a both first surface 120 for abutting with the first link 14 and second surface 122 for abutting with the second link 16. The surfaces 120 and 122 may take the place of the separate elements, such as portion 14 and resilient element 112 as seen in FIGS. 1 and 2.

Although the embodiments illustrated in the Figures show an arrangement for a trunk, hood, or lid opening upwardly and closing downwardly, i.e., vertical opening and closing, the principles of the position retainers, such as the use of a single stop elements 100, may be applied to other orientations, such as with side doors or other devices, which open and close laterally, i.e., horizontal opening and closing.

The foregoing embodiments have been provided to illustrate the structural and functional principles of the present invention, and are not intended to be limiting. To the contrary, the present invention is intended to encompass all modifications, alterations, and substitutions within the scope of the appended claims.

What is claimed is:

1. A hinge for use in a motor vehicle, comprising:
a first member;
a second member coupled to said first member so that said second member may move with respect to said first member in an opening direction, which is away from said first member and towards an open position, and in a closing direction, which is away from said open position and towards said first member and a closed position; and
a third member coupled between said first member and said second member,
said third member including a stop element positioned such that said stop element abuts said second member when said second member is in said open position to keep said second member from further moving in the opening direction, the position of said stop element also being positioned to abut said first member when said second member is in said closed position.

2. A hinge according to claim 1, wherein the third member is constructed to releasably secure said second member in the open position.

3. A hinge according to claim 1, wherein
said stop element includes a resilient portion.

4. A hinge according to claim 1, wherein
said first member is a first link structured and arranged to be coupled to a first part of a motor vehicle, and
said second member is a second link structured and arranged to be coupled to a second part of a motor vehicle.

5. A hinge according to claim 1, further comprising:
a fourth member coupled between said first and second members to form a linkage with said first, second, and third members.

6. A hinge according to claim 2, further comprising:
a fourth member coupled between said first and second members to form a linkage with said first, second, and third members, wherein the third and fourth members move in an over center manner to releasably secure the second member in the open position.

7. A hinge according to claim 1, wherein
said stop element is rigidly positioned on said third element.

8. A hinge according to claim 1, wherein
one of said first and second members includes an adjustable protruding part, which contacts said stop element.

9. A hinge according to claim 8, wherein
said adjustable protruding part is threaded.

10. A hinge according to claim 9, wherein
said adjustable protruding part is a threaded fastener.

11. A hinge according to claim 1, wherein the third member is pivotally coupled to the first member.

12. A hinge according to claim 5, wherein the third and fourth members are each pivotally coupled to the first and second members.

13. A hinge according to claim 6, wherein the third and fourth members are each pivotally coupled to the first and second members.

14. A hinge assembly for a motor vehicle, comprising:
a first member coupled to a first part of a motor vehicle;
a second member coupled to a closure of said motor vehicle and being coupled to said first member so that said closure may move with respect to said first part of said motor vehicle such that said closure may move in an opening direction, which is away from said first part and towards an open position, and in a closing direction, which is away from said open position and towards said first part and a closed position; and
a third member coupled between said first member and said second member,
said third member including a stop element positioned such that said stop element abuts said second member when said closure is in said open position to keep said access panel from further pivoting in the opening direction, the position of said stop element further permitting the stop element to abut said first member when said access panel is in said closed position.

15. A hinge according to claim 14, wherein the third member is constructed to releasably secure said second member and the closure in the open position.

16. A hinge assembly according to claim 14, wherein
said closure is a trunk lid.

17. A hinge assembly according to claim 14, further comprising:
a fourth member coupled to each of said first and second members to form a linkage with said first, second, and third members.

18. A hinge according to claim 15, further comprising:
a fourth member coupled between said first and second members to form a linkage with said first, second, and third members, wherein the third and fourth members move in an over center manner to releasably secure the second member in the open position.

19. A hinge assembly according to claim 14, wherein
said stop element includes a resilient portion.

20. A hinge assembly according to claim 14, wherein
said stop element is rigidly positioned on said third element.

21. A hinge assembly according to claim 14, wherein
one of said first and second members includes an adjustable protruding part, which contacts said stop element.

22. A hinge assembly according to claim 21, wherein
said adjustable protruding part is threaded.

23. A hinge assembly according to claim 22, wherein
said adjustable protruding part is a threaded fastener.

24. A hinge according to claim 14, wherein the third member is pivotally coupled to the first member.

25. A hinge according to claim 17, wherein the third and fourth members are each pivotally coupled to the first and second members.

26. A hinge according to claim 18, wherein the third and fourth members are each pivotally coupled to the first and second members.

27. A hinge for use in a motor vehicle, comprising:
a first member;
a second member coupled to said first member so that said second member may move with respect to said first member towards an open position and towards a closed position; and
a stop element that abuts a first surface of said hinge when said second member is in said open position to restrict hinge movement and abuts a second surface of said hinge when said second member is in said closed position to restrict hinge movement.

28. A method of forming a hinge for use in a motor vehicle, comprising:
providing a first member;
providing a second member;
coupling the second member with respect to the first member between an open position and a closed position; and
providing a stop element that abuts a first surface of the hinge when the second member is in the open position to restrict hinge movement and abuts a second surface of the hinge when the second member is in the closed position to restrict hinge movement.
